(19) United States
(12) Patent Application Publication
(10) Pub. No.: US 2013/0147767 A1
(43) Pub. Date: Jun. 13, 2013

(54) Dispersion-Based Acoustic Touch Signal Detection and Reflector-Based Dispersion Mitigation

(71) Applicant: Francis Lau, Fremont, CA (US)

(72) Inventor: Francis Lau, Fremont, CA (US)

(21) Appl. No.: 13/323,631

(22) Filed: Dec. 12, 2011

(51) Int. Cl. G06F 3/043

(52) U.S. Cl. 345/177

(57) ABSTRACT

A method of detecting a touch event includes transmitting acoustic signals across a substrate, and receiving the acoustic signals. The received acoustic signals have a waveform profile with a dip indicative of a touch on the substrate. The method further includes determining a dispersion level of the dip from the waveform profile, and determining a location coordinate of the touch on the substrate based on the dispersion level.

### BACKGROUND

Touch input systems detect touch events, such as a touch from a user's finger, a stylus, or some other device. Touch regions of the touch input systems are often transparent for use with an information display of a computer or other electronic system. Other touch input systems are opaque touch sensors, such as touch or track pads. Touchscreens and other touch input systems are used in a variety of applications, such as information kiosks, retail points of sale, order entry systems (e.g., restaurants), industrial process control applications, interactive exhibits, mobile phones and other personal electronic devices, and video games.

Some touch input systems use acoustic signals to detect touch events. Certain types of acoustic touchscreens, also known as ultrasonic touchscreens, detect touch with high transparency and high resolution, while providing a durable touch surface. Of particular commercial interest are ultrasonic touchscreens using surface acoustic waves (SAW).

SAW touchscreens often have a glass overlay on which transmitting and receiving piezoelectric transducers are mounted. A controller sends an electrical signal to the transmitting transducer, which converts the signal into ultrasonic waves on the surface of the glass. These waves are directed across the touchscreen by an array of reflectors. Reflectors on the opposite side direct the waves to the receiving transducer, which reconverts the waves into an electrical signal. The process is repeated for each axis. A touch absorbs a portion of the waves traveling across the touch region on the surface. The received signals for X and Y are compared to stored digital maps, the change is recognized, and a coordinate is calculated.

Problems arise for many touchscreens when two touch events occur simultaneously. The multiple touches cause two X and two Y attenuation locations. An ambiguity arises as to the proper pairing of the X and Y locations. Past attempts to resolve the ambiguity from multiple simultaneous touches have relied upon (1) faster sampling in the hope that the two touch events can be distinguished because the events are not truly simultaneous, (2) touch depth differentiation, and (3) touch width differentiation. These techniques may not sufficiently address all multiple-touch events, leaving some ambiguities unresolved.

### SUMMARY

In a first aspect, a method of detecting a touch event includes transmitting acoustic signals across a substrate, receiving the acoustic signals, the received acoustic signals having a waveform profile with a dip indicative of a touch on the substrate, determining a dispersion level of the dip from the waveform profile, and determining a location coordinate of the touch on the substrate based on the dispersion level.

In a second aspect, a system includes a substrate configured to support propagation of acoustic signals across the substrate, a transducer in communication with the substrate and configured to receive the acoustic signals after the propagation of the acoustic signals across the substrate and to generate a waveform representation of the received acoustic signals, and a controller configured to detect a touch on the substrate occurring during the propagation of the acoustic signals. The controller detects the touch based on a dip in the waveform representation of the received acoustic signals, and the controller is configured to determine a location coordinate for the touch based on a dispersion level of the dip.

In a third aspect, a touch input system includes a substrate configured to support transmission of an acoustic signal, a transducer in communication with the substrate and configured to receive the acoustic signals after the propagation, and an array of reflectors disposed on the substrate. Each reflector is oriented on an angle to redirect the acoustic signals along a path toward the transducer. The transducer includes a stepped interface for the redirected acoustic signals. The stepped interface includes a set of interface elements distributed across a width of the redirected acoustic signals and offset from one another along the path to compensate for the angle of the reflectors.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the drawings are not necessarily to scale, emphasis instead being placed upon illustrating the principles of the invention. Moreover, in the drawings, like reference numerals designate corresponding parts throughout the different views.

FIG. 1 is a flow diagram of an example embodiment of a method of determining a touch event location based on a degree to which an acoustic signal has dispersed since the touch event.

FIG. 2 is a top view, schematic diagram of an example embodiment of a touch input system with dispersion-based touch detection according to one embodiment.

FIGS. 3A and 3B are schematic diagrams and associated graphical plots illustrating varying amounts of dispersion of acoustic signals after touch events according to one example.

FIGS. 4A and 4B are top view, schematic diagrams and associated graphical plots illustrating dispersion mitigation of acoustic signals after touch events using a stepped transducer topology configured in accordance with one embodiment.

FIG. 5 is a partial, top view, schematic diagram of another example embodiment of a stepped transducer topology mounted on a backside of a touchscreen or other touch input system substrate.

FIG. 6 is a bottom, perspective view of a mode conversion wedge having multiple stepped interfaces in accordance with one embodiment.

### DETAILED DESCRIPTION OF SPECIFIC EMBODIMENTS

Systems, devices, and methods are configured for detecting touch events on an acoustic touchscreen or other acoustic touch input system. Touch input systems and methods are configured to determine touch position based on dispersion of acoustic signals. One or more coordinates of the position of the touch event may be determined via an analysis of a dispersion level of an acoustic signal interacting with the touch event. Dispersion of the acoustic signal effectively results in spreading out the acoustic signal along the surface of a touchscreen or other touch substrate. Such spreading may result from the nature of wave propagation around an obstacle that gives rise to diffraction or interference effects. The level of dispersion of the acoustic signal increases as the signal travels through or along the touchscreen substrate, e.g., between transmit and receive transducers. The level of dispersion in the acoustic signal increases as the travel distance to a receive reflector array increases. The degree to which dispersion occurs after a touch event may also be indicative of the distance between the touch event and the receive reflector array. Dispersion of the acoustic signal that arises from factors other than those indicative of touch position, such as those caused by an angled frit array, may be mitigated via a stepped transducer topology.

With information indicative of dispersion, touch position may be detected for an axis perpendicular to a frit or other reflector array that collects acoustic signals affected by the touch. A touchscreen or other system may determine both touchscreen coordinates (e.g., X and Y) of a touch event using only sensing structures for a single axis, according to a specific embodiment. Indirect measurement along the touchscreen axis perpendicular to the reflector array may include measuring the amount of acoustic wave dispersion after a touch event. The sensing structures for a single axis may include one or more transducers and one or more reflector arrays to capture timing information for the touch event. The touchscreen may use the timing information to determine a first one of the touchscreen coordinates and use the dispersion information to determine a second one of the touchscreen coordinates. Use of the dispersion information may be used to detect position along a new axis using no additional screen area to print reflector (e.g., frit) arrays for the second axis (e.g., the axis perpendicular to the axis having the sensing structures). Thus, a touch input system using dispersion information may determine single- or dual-touch position coordinates (e.g., X and Y) using only a single transmit/receive reflector array pairing with corresponding transmit and receive transducers, according to a specific embodiment.

The dispersion tracking techniques are not limited to a specific transducer arrangement. In some cases, one or more touch position coordinates may be determined based on a reflection signal from the touch. The reflection data may be used in addition to, or as an alternative to, the dispersion tracking technique. The time of flight of the reflection signal may be used to determine a distance from the receiving transducer(s). The transducers detecting the reflection signals may be dedicated to detecting reflection signals or also used in other touch sensing functions, such as transmission or reception of other signals. One or more reflection transducers may be configured as a radial or U-axis transducer.

The dispersion-based touch detection technique may be used in conjunction with systems having sensing structures to support touch location detection for more than one axis. For example, a touchscreen system may include both X- and Y-axis sensing structures, and/or a U-axis sensing structure(s), each determining touch position coordinates for a respective axis based on time-of-flight or other timing information. In addition to the availability of position information from the sensing structures for each such axis, the touch input systems may also detect and analyze dispersion levels of the X and/or Y acoustic signals to provide further information regarding the X and Y position coordinates. Such information may be useful in connection with detecting dual- or other multi-touch events or other touch events that may create coordinate detection ambiguity. Dispersion information may be useful in touch input systems that do not include a third axis with sensing structures (e.g., a diagonal U axis) to resolve such ambiguities. For example, touchscreens for use with a zero bezel arrangement (e.g., screens with a completely flat front surface) may include sensing structures for only X and Y axes due to physical limitations that create undesirably large dead zones for a U axis.

Dispersion analysis is not limited to touch substrates or regions of any specific size. In some embodiments, the touch substrate or region may be sized or otherwise configured for a tablet, mobile phone or other personal or handheld device. The touch substrate or region may have one or more dimensions on the order of a few inches or less. The dimensions of the touch substrate or region may vary based on a number of factors, including, for instance, the tolerance or other characteristics of the reflector arrays and other structures that may minimize distortion (e.g., interference and other noise) of the ray-like behavior of the acoustic signals.

The degree of dispersion of the acoustic signals may be clarified and/or mitigated via a modified transducer topology. The dispersion signals may be weak and difficult to detect given noise in the system and parasitic interference. While low noise amplifiers may be used to determine a degree or level of dispersion, a transducer topology or interface that mitigates dispersion effects inherent to reflector array-based touch detection may be used to aid in extraction of the dispersion effect of interest.

The transducer topology may present a stepped transducer interface. The interface may include a stepped transducer structure or multiple transducer structures in a stepped arrangement. The stepped transducer topology allows a received acoustic signal to be less convoluted. The attenuation (hereinafter “dip”) in the acoustic signal arising from a touch event may thus be sharper than with a non-stepped transducer topology. By increasing the clarity of the received acoustic signal, the stepped transducer topology may enhance the resolution of a touchscreen or other touch input system. The stepped transducer interface may vary the placement of the transducer, or a mode conversion wedge of the transducer, across the width of an incoming acoustic signal to be received. The varied placement of the transducer interface may match, compensate, or otherwise address the profile of the incoming acoustic signal, which is shaped by the reflector array that redirects the signal toward the transducer interface. The incoming acoustic signal may be oriented at a 45 degree angle relative to the transducer as a result of the 45 degree orientation of the reflector array in a specific embodiment. The varied placement of the transducer interface may lead to a parallel reception of components of the incoming acoustic signal. The varied placement of the transducer interface may involve multiple, discrete, spaced apart transducers, or a single transducer with a stepped surface, e.g., a stepped mode conversion wedge.

The stepped transducer topology is not limited to touch input systems that determine touch position based on dispersion level. Any of the examples of the stepped transducer topology described below may be used in a touch input system that determines touch position via time-of-flight analysis and/or via other techniques involving detecting the timing of an acoustic signal dip or other attenuation indicative of a touch event.

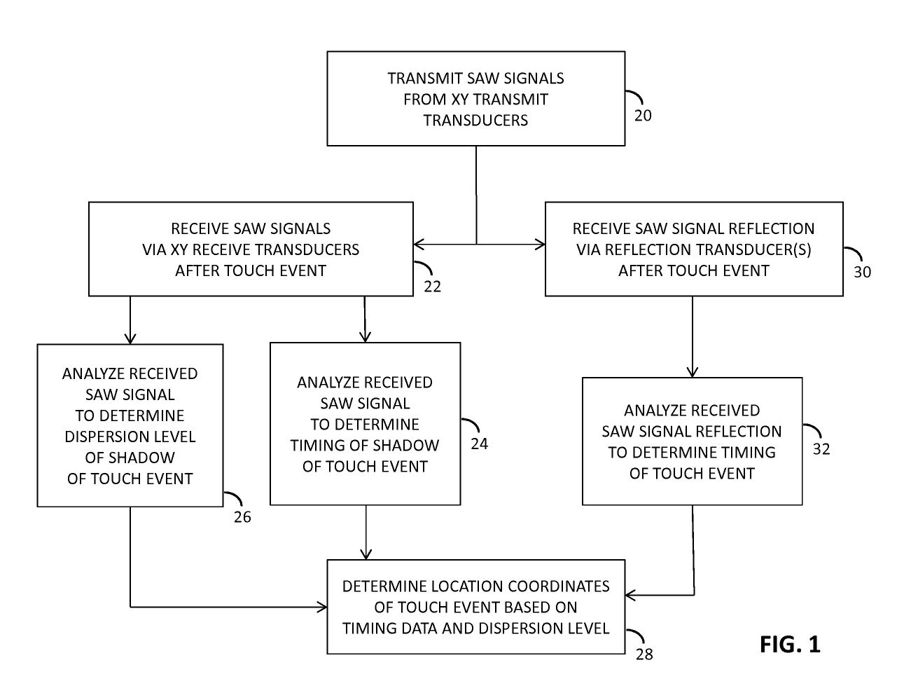

FIG. 1 is a flow diagram showing a method of detecting a touch event on a touchscreen or other touch input system. The touch detection method is based on the propagation and detection of acoustic signals through or on a substrate of the touchscreen or touch input system. The configuration of the substrate may vary. The acoustic signals may travel along a surface of the substrate as surface acoustic wave (SAW) signals. In act 20, one or more SAW signals are transmitted from one or more transducers in communication with the substrate. In one example, SAW signals are transmitted, either concurrently or alternately in various embodiments, from a pair of transducers, each transducer being part or one of the sensing structures for a respective axis. For instance, the SAW signals may be generated by X and Y transducers associated with an X axis and a Y axis perpendicular to the X axis, respectively. Respective arrays of transmit reflectors may be spaced along the axes to redirect the SAW signals across the substrate along perpendicular paths. For example, SAW signals transmitted by the X transducer are reflected by the transmit reflectors spaced along the X axis, resulting in the SAW signals propagating across the substrate along the Y axis. Similarly, SAW signals transmitted by the Y transducer are reflected by the transmit reflectors spaced along the Y axis, resulting in the SAW signals propagating across the substrate along the X axis. When a touch event occurs on the substrate surface, the touch interacts with the SAW signals at corresponding positions along the axes. The interaction causes attenuation of the SAW signal, which appears as a dip in a waveform profile of the SAW signal. After the touch event, receive reflectors spaced along opposite sides from the transmit reflectors may redirect the SAW signals toward one or more receive transducers, e.g., X and Y receive transducers. The SAW signals are then captured by the receive transducers in act 22. The receive transducers convert the SAW signals into electrical signals. Because different path lengths are provided for SAW signals, the received signals represent a waveform profile where different times correspond to different location along a given axis.

The position of the touch event may then be determined based on analysis of the received SAW signals in acts 24, 26. The position is specified by coordinates referencing the axes. In act 24, the received SAW signal is analyzed to determine the timing of the dip in the SAW signal waveform profile. For each received SAW signal, the timing of the dip in the signal may be used to determine the position (or coordinate) along the axis of the transmit and receive reflector arrays redirecting that SAW signal. The other axis coordinate may be determined by another SAW signal received by a different transducer, and/or via the dispersion-based analysis described below.

The received SAW signal is also analyzed in act 26 to determine a dispersion level of the SAW signal. The dispersion level may be used to determine the position along an axis other than the axis for which the reflectors and other sensing structures are configured. The dispersion level analysis implemented in act 26 may be directed to determining the amount, degree, level, or magnitude of dispersion of the SAW signal after the touch event. The received SAW signal may thus be analyzed to determine a dispersion level of the dip in the SAW signal waveform. As described below, the dispersion of the SAW signal affects the waveform profile, including the SAW signal in or near the dip caused by the touch event. The extent to which the SAW signal is dispersed after the touch may reduce the attenuation level of the SAW signal. The amount of dispersion in the part of the waveform profile associated with the dip may be indicative of the distance traveled by the SAW signal from the touch location to a frit or other reflector array, transducer, or other sensing structure for an axis. For example, a touch location at a distance of 5 cm away from the X axis is to be determined. The received dispersion information processed in act 26 may then be used to determine the coordinate of the touch location along an axis perpendicular to X axis. The 5 cm distance away from the X axis indicates a Y-axis position.

The location of the touch event may be determined in act 28 based on the timing of the dip and the dispersion level. With both the dip timing and dispersion level data, touch input systems having sensing structures for only a single axis (e.g., a single transmit/receive transducer pairing) may determine the coordinates along both axes (e.g., X and Y). For example, the coordinate referencing the X axis may be generated based on the timing of the dip, and the coordinate referencing the Y axis may be generated based on the dispersion level of the dip.

Touch input systems with sensing based on timing for multiple axes may also benefit from the dispersion level data. The touch input system transmits respective SAW signals for each axis, such that both axis coordinates may be determined by dip timing analysis. Dispersion level analysis of each received SAW signal may still be used. For instance, the dispersion level may be used to resolve ambiguities, such as those presented by multiple-touch events. The X coordinate determined by the dip timing from the sensing structures of the X axis may be confirmed or otherwise compared with the X coordinate determined via the dispersion level. An adjustment in or selection of the X coordinate may then be made based on the comparison.

Practice of the disclosed method is not limited to a particular transducer configuration. The transmit and receive transducers described herein may vary in construction and other characteristics. For example, one or more of the transmit and receive transducers may be a wedge transducer, and include a mode conversion wedge constructed of, for instance, acrylic glass (e.g., the thermoplastic material commercially available as PLEXIGLAS™, LUCITE® or ACRYPET®). A piezoelectric element of the wedge transducer generates acoustic waves, such as bulk pressure waves, in the wedge. The piezoelectric element may be constructed of a ceramic material such as lead zirconate titanate (PZT). At the boundary of the wedge with the glass substrate of the touch surface, surface acoustic waves are generated. Alternatively or additionally, one or more of the transmit and receive transducers may be a grating transducer. The method may include one or more SAW signals being transmitted, received, or captured by one or more radial or U-axis transducers mounted in, for instance, a corner of the touchscreen. Alternatively or additionally, one or more of the receive transducers may capture the SAW signals via a stepped interface configured to mitigate reflective array-based dispersion of the acoustic signal, as described below.

The example method of FIG. 1 may also include the transmission and/or reception of one or more reflective SAW signals. Energy from one or more transmitted SAW signals may be reflected as a result of interaction of the SAW signal with the touch, and eventually captured by one or more receive transducers. The SAW signals may be transmitted to cause the reflection(s), or the reflections may be generated as an incidental consequence of the SAW signals transmitted in act 20. Thus, the reflective signals may be generated from SAW signals dedicated to causing the reflections, or from the SAW signals used for dip detection. Thus, the transducers transmitting the SAW signals intended for reflection-based reception may, but need not, be in addition to the transmit transducers involved in act 20.

The reflective SAW signals are received in act 30 after the touch event. In this example, the reflective SAW signals are detected by one or more reflection transducers configured to receive the reflections. The reflection transducer(s) may correspond with the transducer(s) used to transmit the SAW signals causing the reflection(s). The reflective acoustic signal may be captured via any one of the transmit transducers in acoustic communication with the touchscreen, each such transducer being switched to a receive mode after the SAW signal is transmitted. The transducers may be switched between transmit and receive modes by the touch controller. Alternatively or additionally, one or more of the receive transducers used to receive the attenuated SAW signals for the axes may be used to receive the reflective SAW signals. Such reception may thus involve redirection via one or more of the reflective arrays.

In some embodiments, the reflection signals are transmitted and/or received via radial transducers. Once the time of flight is determined, the distance from the transducer(s) may be resolved. Because the reflection signal may be a bit convoluted (e.g., the center of the touch is not very well defined), a signal smoothing operation may be implemented. Using this information, data indicative of a single x/y coordinate may be combined with the radial data. The received radial reflection signal may be noisy due to gain provided after reception. The noise may arise from an amplifier, such as a low-noise amplifier (LNA), and/or resulting from parasitic reflections from a transmit transducer (e.g., when using the same transducer to transmit and receive). Another source of parasitic noise may include reflection off an edge of the touchscreen. Touch location detection based on reflection signals may alternatively or additionally use a sweeping method, such as a phased array technique.

After the reflection or other transducer(s) receives the reflective SAW signal, the touch controller analyzes in act 32 the reflection data to determine a timing of the touch event. The analysis may include a determination of the travel time of the reflective SAW signal. Using a known or estimated speed of propagation and the known transmission source location, the time indicates a distance between the transducer and a position at which the reflection occurred. One or more position coordinates may then be determined in act 28 based on the travel or arrival time of the reflective acoustic signal, in combination with other information gathered from other acoustic signals. For example, the arrival time of the reflective SAW signal may be used to refine, correct, or otherwise adjust a position coordinate determination based on the dispersion level analysis. The combination of the reflection and dispersion level analyses may allow the touch input system to detect multiple coordinates using sensing structures for only a single axis. Alternatively or additionally, the arrival time of the reflective SAW signal may be used to resolve ambiguities arising from dual- or other multiple-touch scenarios.

The SAW signals causing the reflections may differ from those involved in the attenuation and dispersion level analyses. The reflection analysis may benefit from a longer SAW signal than a single cycle transmission. For example, the transmitted SAW signal may include a plurality of cycles. The plurality of cycles may lead to a pulse duration greater than or about equal to the width of the reflector arrays. Such increased signal length may be useful to ensure that sufficient energy is captured by the receive transducer. The reflection signal may receive the time of flight information using a single large pulse. However, due to the attenuation of SAW signals, more than a single large pulse may be used to distinguish the signal from noise. Alternatively or additionally, a chirp transmit signal may be used in reflection-based SAW detection.

The configuration of the transducers used to receive the reflective SAW signals may vary. In one example, the reflective signals are captured via a radial transducer. Alternatively or additionally, the reflective signals are captured by one or more of the transducers mounted and otherwise configured to capture the SAW signals for a respective axis.

Practice of the disclosed methods is not limited to those touch input systems transmitting signals for reflection analysis or those otherwise receiving reflective signals to determine touch location. For instance, the dispersion level-based techniques need not be used in conjunction with an analysis of one or more reflective signals. The dispersion level information may be useful as described herein in touch input systems without relying on detection of reflections from touch events.

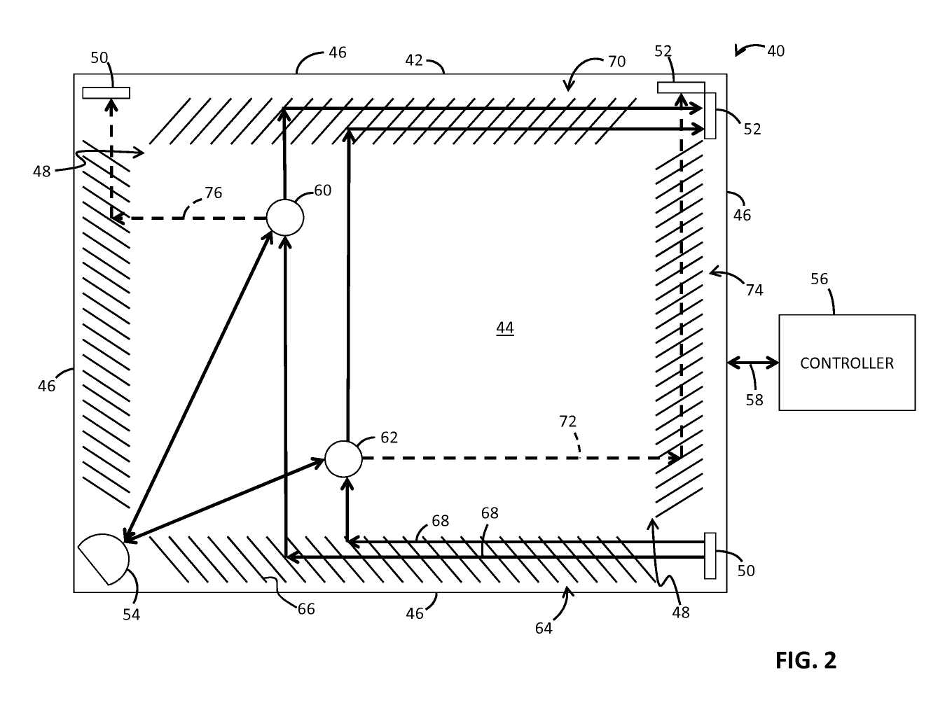

FIG. 2 is a schematic, top view of a touch input system 40 configured to implement one or more of the above-described touch detection methods and techniques. The touch input system 40 includes a touchscreen or other substrate 42 configured to support propagation of an acoustic signal, such as a SAW signal, across the substrate 42. The substrate 42 may be a display screen or an overlay disposed upon the display screen. For example, the substrate 42 may include a glass display overlay through or on which the SAW signals travel. The substrate 42 includes a touch-sensitive area or region 44 having two or more axes. The touch area 44 may correspond with a viewable area of a display in an assembled device, and may also extend beyond the viewable area. In this example, the touch area 44 is defined by a Cartesian coordinate system via two orthogonal axes X and Y. The touch area 44 may be defined by polar and other coordinate systems in other embodiments.

The touch input system 40 includes an arrangement of transducers disposed along one or more side edges 46 of the substrate 42 or adjacent to the region 44. The side edges 46 and the transducer arrangement define an outer border or periphery 48 of the touch area 44. The outer border 48 and, thus, the touch area 44 may also be generally defined by a bevel (not shown) or other cover protecting the transducers and other components of the touch input system 40 in some embodiments. Each transducer is mounted on or otherwise disposed in communication with the substrate 42 in a position proximate one or more of the edges 46. The touch input system 40 may include transmit transducers 50 to produce the acoustic signals, and receive transducers 52 to receive the acoustic signals after propagation across the substrate 42 to generate an electrical waveform representation of the received acoustic signal. Alternatively or additionally, the touch input system 40 may include one or more transducers directed to both transmission and reception. In this example, the touch input system includes a radial or U-axis transducer 54, which both produces and captures acoustic signals.

The number and type of axes having sensing structures may vary, including those embodiments in which the touch input system 40 provides touch position coordinates for multiple axes (e.g., X and Y) based on sensing structures disposed along a single axis. In this example, the touch input system 40 includes respective sensing structures for three axes, two Cartesian axes and one non-Cartesian (e.g., radial) axis. Respective transmit transducers 50 are provided for each axis of the touch input system 40 in respective corners of the touch area 44. Respective receive transducers 52 are provided for the Cartesian axes of the touch input system 40. The receive transducers 52 need not be disposed in a common corner of the touch area 44, as in the example shown. The number, arrangement, and configuration of the transmit and receive transducers 50, 52 for the Cartesian axes may vary from the example shown. The radial or U-axis transducer 54 in this example is disposed in a corner of the touch area 44 opposite the receive transducers 52. The radial axis need not rely on a transducer operating in both transmit and receive modes, and the radial transducer 54 need not be disposed in a corner of the touch area 44. The touch input system 40 need not include a radial or other non-Cartesian axis, and may include more than one radial transducer in other embodiments.

The touch input system 40 includes a controller 56 configured to direct the operation of the transducers 50, 52, 54. The controller 56 may be coupled to or connected with the transducers 50, 52, 54 via cabling 58 for communication of the electrical signals driving or generated by the transducers. The controller 56, which may be an application specific integrated circuit, may be programmed or otherwise configured to implement the above-described methods and techniques described herein to detect a touch event occurring during the transmission of the acoustic signals. The integrated circuit chip commercially available from Texas Instruments, Inc. under model number THS4131 may be configured for use as an analog front end to the touch controller 56. The controller 56 need not be disposed on a single chip, and may include any number of processors or processing units in communication with a chip or other circuitry directed to handling the electrical signals generated by or delivered to the transducers.

The controller 56 is configured to analyze the waveforms generated by the transducer arrangement to detect one or more touch events at touch locations 60, 62 occurring during the transmission of the acoustic signals. The analysis may include determining the timing of a dip(s) in one of the waveform representations of the received acoustic signals. The controller 56 may then generate a coordinate of the touch location 60, 62 based on the timing of the dip, the coordinate referencing one of the axes of the touch area 44. The analysis implemented by the controller 56 may also include determining the dispersion level of the dip to generate a coordinate referencing the other axis of the touch area 44.

The touch input system 40 may rely upon signals from sensing structures for one or more of the three axes to determine each location coordinate of the touch locations 60, 62. A combination involving more than one of the axes may be used by the controller 56 to resolve ambiguities arising from, for instance, the touch events at the locations 60, 62 occurring simultaneously. Signals from sensing structures for more than one axis may be used by the controller 56 to determine a location coordinate to refine or otherwise adjust the data determined by the sensing structures for one of the axes. One example operation is shown in FIG. 2 for determining both the X and Y coordinates from transmit and receive transducers 50, 52 for the X axis. The transmit transducer 50 in the lower right-hand corner of the substrate 42 produces a SAW signal that travels along a frit or other array 64 of reflectors 66, each reflector 66 being oriented on an angle (e.g., 45 degrees) to redirect a portion of the SAW signal along a path across the touch area 44. Each reflector 66 of the array 64 may be constructed of frit disposed on the substrate 42. However, the reflector spacing, construction, mounting, material, configuration, and other characteristics of the array 64 may vary from the example shown. The SAW signal for the X axis is depicted schematically as a number of rays 68 that are eventually reflected by the array 64 for interaction with the touch events at the locations 60, 62, where the attenuation of the SAW signal occurs. Example rays are provided, but other SAW signals exist on the touch area 44. The SAW signal passes through the touch locations 60, 62 and reaches another frit or other reflector array 70 disposed along the side edge 46 opposite the side edge 46 having the array 64. The reflectors of the array 70 redirect the SAW signal toward the receive transducer 52 of the X axis, at which the energy of the SAW signal is received and converted into an electrical waveform having dips indicative of the touch locations 60, 62.

Each dip may then be analyzed by the controller 56 to determine the X coordinates of each touch location 60, 62. Based on the timing of the dips, the X coordinate locations of the two touch locations 60, 62 may be determined. A similar analysis of the timing of waveform dips may be implemented for the Y axis using the other transmit and receive transducers 50, 52. However, there are two X coordinates and two Y coordinates, providing four possible locations. There may be ambiguity where the two touch events at the locations 60, 62 occur at a same time. Each of the coordinates determined via the dip timing analysis may be confirmed, refined, or otherwise further determined via analysis of the dispersion level of the waveform dips and/or the analysis of one or more reflective signals.

The example shown in FIG. 2 also depicts several optional techniques for using reflective signal analysis to determine, or assist in determining, the location of the touch events 60, 62. The location of a touch event may be determined using one or more reflected acoustic signals. Each touch event creates reflected waves that may be detected by one or more of the transducers 50, 52, 54 on the substrate 42. In the depicted example, the receive transducer 52 for the Y axis captures a reflective SAW signal indicated schematically at 72, which travels from the touch location 62 to the transducer 52 via a reflector array 74 of the Y axis. The controller 56 may use the arrival time of the reflective SAW signal 72 to refine the X coordinate of the touch location 62.

One or more of the transmit transducers 50 may be switched to a receive mode after signal transmission to capture the reflections. In one example, the transmit transducer 50 for the X axis may be switched to a receive mode for detection of a reflection signal that retraces a respective one of the paths of the rays 68. Alternatively or additionally, the transmit transducer 50 for the Y axis may be used to capture a reflective signal indicated schematically at 76, which results from a transmission (not shown) initiated at the transmit transducer 50 for the Y axis. The reflective signal 76 retraces the path of the transmission as a direct reflection from the touch event 60. Such transmit transducers may be useful to minimize the distance traveled by the reflective signals. A shorter wave travel distance may be useful because the reflective signals are generally weaker than the signals passing through a touch event. Thus, the signal strength of the reflective signal 76 may be greater than the signal strength of the signal 72, which has to travel much farther to reach the transducer 52. In some embodiments, the receive transducers 52 may also or alternatively be switched between transmit and receive modes. In one example, the transducer 52 for the X axis may transmit a signal that is detected by the transducer 52 for the Y axis after a 90 degree reflection off of a touch event.

The radial or U-axis transducer 54 may also be used to capture signals reflected from the touch events at the locations 60, 62. The reflective signals may be created by a reflection of a signal generated by one of the transmit transducers 50 for the X and Y axes, or be created by a reflection of a signal generated by the radial transducer 54. Either way, the arrival time of the reflective signal may be used by the controller 56 to refine or otherwise determine one or both of the X and Y coordinates of the touch locations 60, 62. Reflections from radial signals may be useful because the radial transducer 54 is positioned to capture the energy reflected 180 degrees from the object touching the surface 42. A significant fraction of the reflected energy is directed 180 degrees from the direction of the transmitted signal. In the example shown, the radial transducer 54 is directed to generate a number of radial SAW signals and then switch to a receive mode to capture the reflections. The controller 56 may then use the respective time-of-flights of the reflections as an indication of the corresponding distances between the radial transducer 54 and the touch locations 60, 62. This resolves the ambiguity to an arc at the distance from the radial transducer 54. The X and Y coordinates along the arc are the touch events at the locations 60 or 62, resolving the ambiguity for multiple touches.

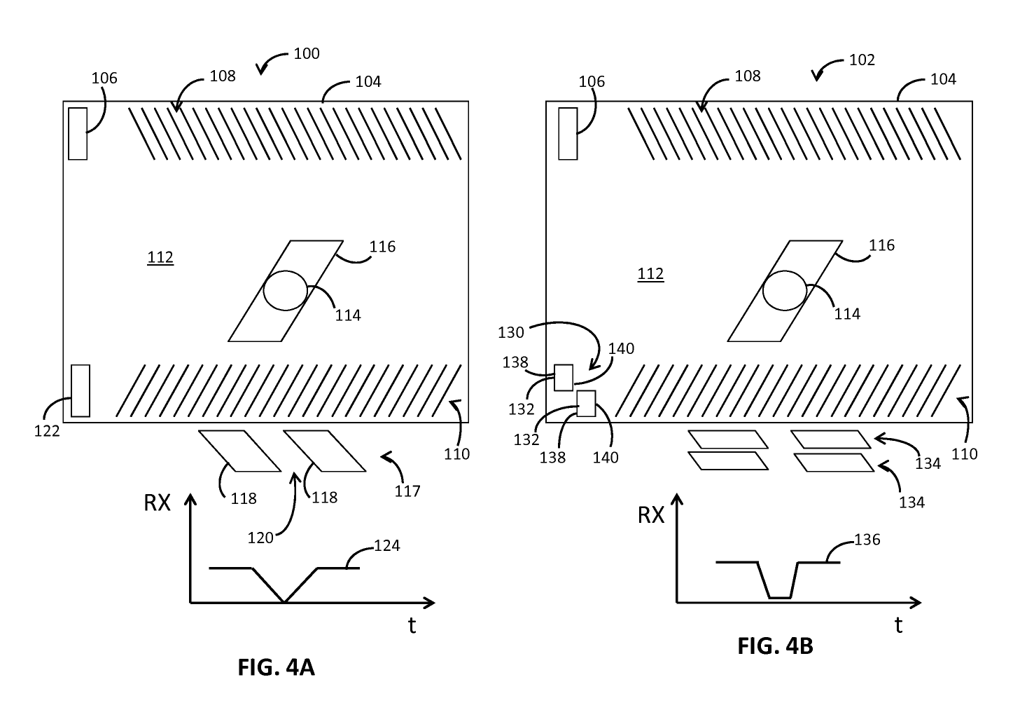

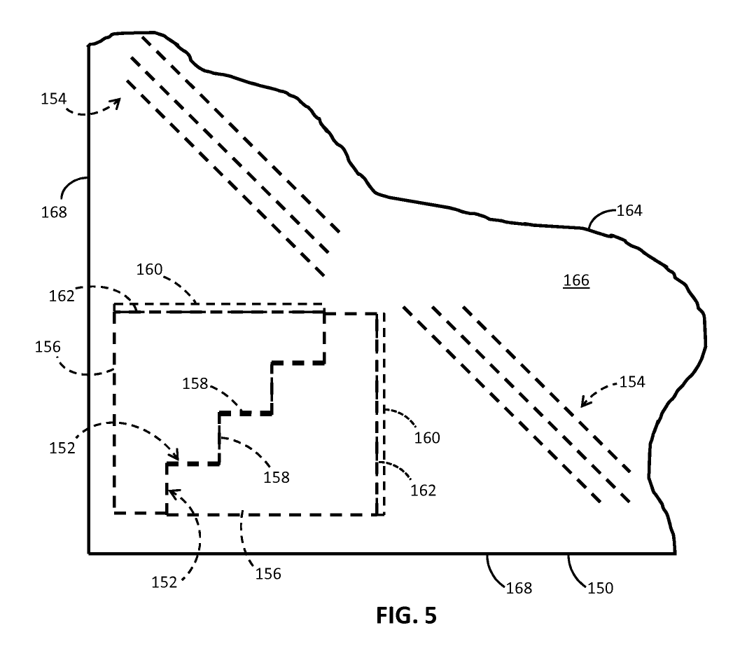

One or more of the receive transducers 52 may be configured with a stepped transducer interface. Each receive transducer 52 may include a mode conversion wedge to convert the bulk pressure waves created by a piezoelectric element into the SAW signal traveling through the substrate 42. As described below in connection with FIGS. 4B and 5, the stepped transducer interface may be formed via the piezoelectric element (FIG. 4B) or the mode conversion wedge (FIG. 5). In the former case, the piezoelectric element includes a plurality of piezoelectric structures offset from one another; while in the latter case the mode conversion wedge has a stepped face to vary the distance traveled in the wedge before the piezoelectric element is reached. In either case, the stepped interface of the receive transducer 52 may help clarify and sharpen the dip by compensating for the spreading of the SAW signal arising from the reflective array that directs the SAW signal to the receive transducer 52. The dispersion created by the array may be mitigated, leaving the dispersion arising from the distance from the touch location 60, 62 to the array more detectable or discernible.

The dispersion level of the dips created by the touch events at the locations 60, 62 may be used to determine, or assist in determining, one or both of the X and Y coordinates of the touch locations 60, 62. The amount of dispersion of the SAW signal increases with the distance traveled since the touch event. For the X axis, the dispersion level of the dip for the touch event at the location 60 is lower than the dispersion level of the dip for the touch event at the location 62. The touch location 60 is closer to the reflective array 70 than the touch location 62. The SAW signal travels farther after the touch location 62, thereby having or experiencing more dispersion. More dispersion results in degradation of the waveform profile of the dip.

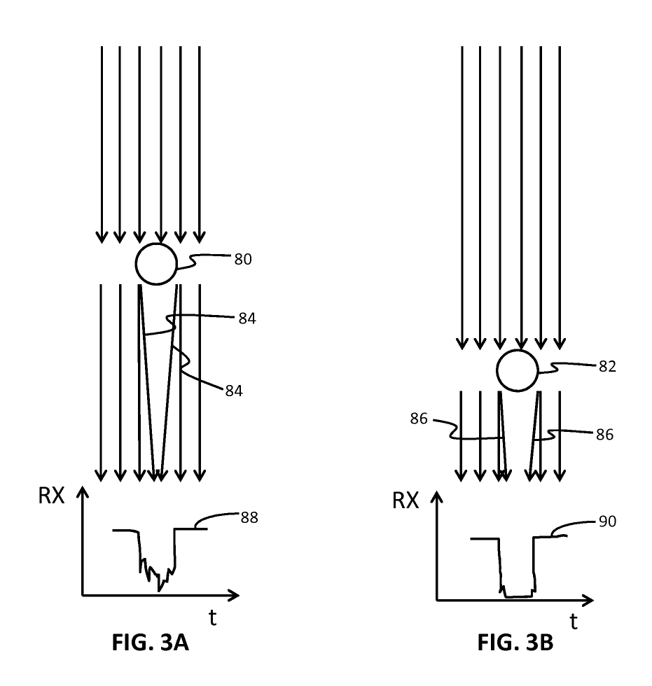

FIGS. 3A and 3B include schematic views and associated graphical plots that illustrate the manner in which the dispersion of the acoustic signal changes the waveform profile of the dip. FIG. 3A shows a distal touch event location 80, and FIG. 3B shows a proximal touch event location 82. The touch locations 80, 82 are distal or proximal based on the relative distance between the touch event and, for instance, a receive reflector array or a receive transducer. As the distance traveled by the SAW signals after the touch event increases, the acoustic energy has a greater opportunity to disperse. Such dispersion of the SAW signals is shown schematically by rays 84, 86 converging after the touch locations 80, 82. The longer travel distance of the rays 84 (representing the waves) allows more acoustic energy to obscure the dip in a waveform profile 88, as shown in the graphical plot of FIG. 3A. In contrast, a waveform profile 90 (FIG. 3B) has a dip relatively unaffected by the rays 86, which have a shorter travel distance to distribute SAW energy into the dip. Thus, the waveform profile 88 for the distal touch event location 80 reflects a greater degree of dispersion than the waveform profile 90 for the proximal touch event location 82. The amount of dispersion in each waveform profile 88, 90 may be analyzed to determine the travel distance and, thus, the position along a line (e.g., the Y axis) of the touch event locations 80, 82.

Given possible locations, such as due to multi-touch ambiguity, the distance detected along this line from the dispersion may resolve the ambiguity. Alternatively or additionally, the distance indicates the location along an axis parallel with the direction of propagation of the SAW signals. Because the dip timing indicates the position along an axis perpendicular to the direction of propagation of the SAW signals, both X and Y coordinates may be determined.

The acoustic energy may be dispersed, and the corresponding waveform profiles of the acoustic signals may be distorted, for reasons other than the relative post-touch travel distance of the SAW signals. The touch input system (or touch controller or processor thereof) may include one or more low-noise circuit components to minimize the introduction of noise after the acoustic energy is captured. For example, the touch input system may include one or more low-noise amplifiers (LNA), such as the fully differential amplifiers commercially available from Texas Instruments under model number THS4131. Distortion may also occur before the acoustic energy is captured by the receive transducers as a result of the dispersion or pulse signal spreading arising from the angled orientation of the reflector arrays. Such array-based dispersion may be addressed by the use of stepped receive transducers, as described below.

FIGS. 4A and 4B illustrate the array-based dispersion of the acoustic signals, as well as the mitigation thereof, in a pair of touch input systems 100 (FIG. 4A) and 102 (FIG. 4B). FIGS. 4A and 4B are top view, schematic diagrams and associated graphical plots illustrating dispersion after touch events. FIG. 4B depicts mitigation of the dispersion of the acoustic signals using a stepped transducer topology configured in accordance with one embodiment. Each touch input system 100, 102 may have a similar touch substrate 104 configured to support transmission of acoustic signals, such as SAW signals, one or more transmit transducers 106 on the substrate 104, and transmit and receive arrays 108, 110 of reflectors disposed on the substrate 104. Each reflector in the arrays 108 is oriented on an angle to redirect the acoustic signals along paths across a touch area 112. The energy of the acoustic signal is altered by a touch event at a location 114. The energy is distributed over a slanted pulse envelope 116 after reflection by the transmit array 108. Because the acoustic signal is redirected by different parts of each reflector in the array 108 at different times, an artifact is created. Assuming the acoustic signal reaches a given angled reflector at a certain time but due to the width of the signal, a portion of the acoustic signal is reflected before another portion. The total effect of a multitude of array elements (e.g., frits) results in the slanted pulse envelope 116. After a dip is created in the pulse envelope via the interaction with the touch at the location 114, the pulse envelope is reflected by the array 110.

As shown in FIG. 4A, the angled orientation of the reflectors in the array 110 creates an acoustic signal distribution 117 with pulse fronts 118 oriented at a corresponding angle (e.g., 45 degrees). A gap 120 in the acoustic energy remains representative of the touch location 114, but the angled pulse fronts 118 result in varying arrival times at a receive transducer 122. The variance in the arrival times, in turn, causes a waveform profile 124 with energy distributed throughout the dip. In one example in which the touch at the location 114 has a width roughly equal to the width of the reflector array, e.g., 16 wavelengths, then the width of the dip may be approximately 32 wavelengths, and the waveform profile 124 is V-shaped with zero width at the lowest, most detectable, level. In some cases, having a wider touch width may not be a problem because the center of the dip can be resolved. A challenge may arise when two touches are in close proximity. In this case, the touches with a wider width may tend to blend together, render the signal difficult to resolve. Additionally, the examples presented show an ideal touch at the touch location 114, where the touch location 114 completely attenuates the SAW signal travelling through. In non-ideal examples, the touch attenuation may follow a gradual profile with the center of the touch having the most attenuation and the edge of the touch having the least attenuation. The increased effective width may also complicate the analysis of the dispersion level. Thus, dispersion analysis may be useful on a signal with very sharp touch edges (i.e. very narrow touch width closer to 16 lambda for the example given).

The example embodiment shown in FIG. 4B includes a receive transducer 130 with a stepped interface configured to reduce the effects of the angled pulse fronts. The stepped interface includes a set of interface elements 132 distributed across a width of the acoustic signal redirected by the array 110. The interface elements 132 are offset from one another in one or more steps along the path traveled by the acoustic signal. The interface elements 132 may be offset by an amount that compensates for the angled orientation of the reflectors in the array 110 (e.g., 45 degrees). In this example, the transducer 130 includes two interface elements, such that each may have a width corresponding to half of the width of the incoming acoustic signal or about half the width of the acoustic signal to be received. The “about” may account for some of the acoustic signal dispersing or manufacturing tolerances resulting in spread of the redirected signal. With two offset interface elements 132, the single acoustic signal distribution 117 of FIG. 4A is effectively transformed into two signal distributions 134 as shown in FIG. 4B. Each signal distribution 134 still has angled pulse fronts that decrease the width of the dip, but the offset of the interface elements 132 causes the signal distributions 134 to be effectively in parallel as shown. The signal distributions 134 arrive at the respective interface elements 132 at the same time, and the gaps in the signal distributions 134 may become aligned, which reduces the degradation of a waveform profile 136 generated by the transducer 130. The alignment of the gaps in the signal distributions 134 improves the effective width of the dip in the waveform profile 136. The overall width of the waveform profile 124 may be 32 wavelengths of the SAW signal with a single point of zero energy, while the waveform profile 136 may have a width of 24 wavelengths, with roughly 8 wavelengths of zero energy as a result of the pulse front compensation. The dip in the waveform profile 136 thus becomes more steep, rendering the dip and its dispersion level more detectable. The transducer 130 may have more than two interface elements, with the slope of the walls of the dip increasing with the number of interface elements accordingly. For example, a stepped transducer with four stepped interface elements may provide a dip with a low level width of 20 wavelengths for an overall dip width of 12 wavelengths.

In the embodiment shown in FIG. 4B, each interface element 132 of the receive transducer 130 includes a respective piezoelectric element. The interface or piezoelectric element 132 may be mounted upon or otherwise disposed along a rear face 138 of a mode conversion wedge 140. Each interface element 132 is discretely formed by a respective structural assembly of piezoelectric and mode conversion components. The offset distance between the interface or piezoelectric elements 132 may, but need not, be set such that the elements 132 are positioned along an angle equal to the angle of the reflector array. Alternatively, the offset distance between the interface or piezoelectric elements may be adjusted via the thickness of the mode conversion wedge 140. The distance traveled by the acoustic energy through the mode conversion wedge 140 may be alternatively or additionally used to adjust the respective arrival times.

FIG. 5 is a schematic, partial top view of another example of a touchscreen or other touch input system 150 having receive transducers with a number of stepped transducer interfaces 152 to compensate for the angled pulse fronts arriving via reflector arrays 154. Rather than include a number of discrete structures for each receive transducer as in the above-described embodiment, the transducer interfaces 152 for a respective axis are provided via a single transducer assembly having a mode conversion wedge 156 with a stepped face 158 to form, for instance, a 45 degree wedge. Two such transducer assemblies are shown in FIG. 5, one for each axis. The mode conversion wedge 156 may be constructed from an acrylic block machined to form the stepped face 158 and fixed to a single piezoelectric element 160 (e.g., a strip) mounted on or otherwise disposed at a face 162 of the wedge 156 opposite the stepped face 158. The acrylic block may be composed of acrylic commercially available as Mitsubishi Acrypet VH001.

Two sets of the transducer interfaces 152 may be disposed in the same corner of the touchscreen, as in the example shown, because the stepped faces 158 fit alongside one another complementarily or in a mated fashion. The transducer interfaces defined by each stepped face 158 may be distributed across the width of the incoming acoustic signal and offset from one another along the path of the signal to equalize the arrival time of each portion of the redirected acoustic signal captured by the corresponding piezoelectric element.

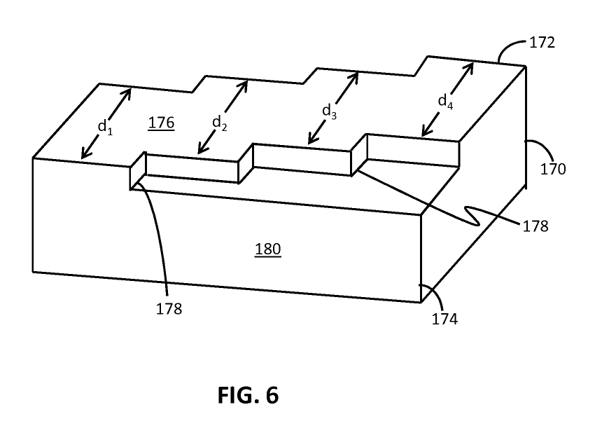

Each step in the face 158 may be offset from neighboring steps to a similar extent that the discrete structures of FIG. 4B are offset, thereby matching the angle of the incoming pulse fronts. The offset may differ from the example of FIG. 4B to compensate for the decreased velocity of bulk waves in the wedge 156. The speed of sound in the bulk of the mode conversion wedge 156 (e.g., acrylic glass) may be significantly slower than the speed of the surface acoustic waves in a substrate 164 of the touch input system 150 through which the acoustic energy travels. The spacing between adjacent steps may vary from the equal spacing arrangement described above in connection with the example of FIG. 4B (e.g., where, for a SAW wave which has a span equal to 16 wavelengths, each discrete transducer step introduces an equal delay of 4 wavelengths). For example, the impact front of each sub-wedge, or step, to the back reflector surface may be determined by the height of the piezoelectric element 160 bonded on the face 162. The piezoelectric element height, the offset of the piezoelectric element from the glass surface, the glass SAW speed, and the acrylic bulk wave speed may be factors in determining the spacing arrangement, as well as an undercut spacing arrangement (e.g., see FIG. 6 and equal lengths d1-d4). The undercut spacing arrangement described in connection with FIG. 6 may match the step spacing of the back reflector. During the overall travel distance, without the undercut spacing arrangement, some of the energy will be traveling at SAW/glass speed while other energy is traveling at acrylic/bulk speed. Note the SAW wave front may be at a 45 degree angle. The spacing between adjacent steps may be compressed from the equal spacing arrangement (e.g., four wavelengths) to account for the difference, and thereby compensate for the varying distances the acoustic energy travels in the mode conversion wedge 156 after impacting the respective step. The variation in spacing may be considered a variable adjustment of the offset for each respective step relative to the non-offset portion of the stepped interface referenced at the face 162. The adjacent reflector steps, and corresponding undercut steps as described in connection with FIG. 6, may thus be spaced from one another based on a bulk wave speed in the acrylic block. The undercut spacing varies the time at which the SAW signals enter the wedge 170, and may thus change the reflector spacing. Bulk waves in acrylic may travel at 2680 m/s, while the SAW waves may travel in glass at 3160 m/s. Despite these different wave propagation speeds, the acoustic energy may still be made to arrive in parallel at the single piezoelectric element 160 through the variation in adjacent step spacing.

The number of stepped faces need not be four as shown. The number of faces may be adjusted in accordance with the amount of compensation provided for the reflector angle. The number of faces may also be selected in accordance with the slight scattering effect experienced by surface acoustic waves. For example, a reflected wave from the farthest part of the screen intended for the top quarter section of the stepped transducer may leak slightly onto a second face. Thus, the number of steps or faces may vary per wavelength of the surface acoustic waves.

The touch input system 150 of this embodiment may be configured for use in a zero-bezel touchscreen. The transducer elements and interfaces of the touch input system 150 may be disposed on a back side of the substrate 164 to remove the need for a protective bezel or cover on a front side 166 of the substrate 164 opposite the back side. Touch events occur on the front side 166, thereby creating dips in the acoustic signals, which are transmitted by the transmit arrays and transducers on the backside to wrap around rounded edges 168 of the substrate and travel across the substrate front side and wrap around an opposite rounded edge 168 to reach the back side where the energy is reflected by the arrays 154 and captured by the stepped transducers. As a result of this travel path, the steps of the transducer interfaces 152 may be configured as reflector steps, insofar as the bulk waves reflect off of each stepped face 158 for redirection backward toward the transducer 160.

The stepped transducers may also include a stepped interface with the substrate. For example, the bottom profile of the stepped transducer may have a footprint touching the substrate with stepped features. Stepped features on the bottom may be included for incoming and/or outgoing waves, e.g., away from and facing the incoming SAW. Such stepped features may support the equalization of the arrival times of the divided surface acoustic waves at the single piezoelectric element 160 as further described below.

FIG. 6 depicts another example of a mode conversion wedge 170 for use in a single-piezoelectric element embodiment. In this example, the mode conversion wedge 170 has an undercut, stepped interface with the substrate. As described below, the undercut interface converts the SAW waves into bulk waves and directs the bulk waves in the wedge 170.

The mode conversion wedge 170 includes a stepped back or rear face 172 to equalize the arrival times as described above. A piezoelectric element (not shown) is disposed at a front face 174 of the mode conversion wedge 170 opposite of the rear face 172. The piezoelectric element may be spaced from a bottom 176 of the mode conversion wedge 170 to avoid affecting the incoming SAW waves as the SAW waves travel in the substrate (not shown) toward the front face 174. The mode conversion wedge 170 is depicted in FIG. 6 with the bottom 176 facing upward to show how the bottom 176 is undercut in a set of undercut steps 178. The bottom 176 may also face upward in zero-bezel and other embodiments in which the wedge 170 is disposed on a back device face.

The set of undercut steps 178 match the reflector steps along the rear face 172. Such matching of the opposing stepped interfaces equalizes distances d₁-d₄ that the bulk waves travel in the wedge 170 before impacting a respective one of the steps along the rear face 172. The length of each distance d₁-d₄ may be selected such that the bulk waves, which may propagate at a 45 degree angle upon entering the wedge 170, travel the same distance before impacting the back face 172. For instance, the distance may be selected such that the bulk waves avoid reflecting off the top of the wedge 170 before impacting the back face 172. The overall travel distance in the wedge 170 (i.e., including travel after reflection off the back face 172) may then be controlled as a function of the distance between the step along the back face and a flat front 180 of the front face 174 along which the piezoelectric element is disposed. The overall travel distance varies to equalize the arrival times at the piezoelectric element as described above.

The offsets between adjacent reflector steps and adjacent undercut steps 178 may vary for the reasons described above in connection with the difference between SAW and bulk wave speeds. Adjacent reflector steps along the rear side 172 may thus be spaced from one another and adjacent undercut steps 178 are spaced from one another based on a bulk wave speed in the acrylic block and on the glass SAW speed, as described above. The variance in the spacing effectively moves up the point at which the incoming SAW wave enters the wedge 170 relative to the theoretical spacing (e.g., four wavelengths in a 16 wavelength spread) for compensating for the SAW wave dispersion. Both the undercut steps 178 and the reflector steps are moved forward to decrease the spacing between adjacent steps to keep the distances d₁-d₄ equal to one another. In the example described above, the adjacent step differential is reduced from four wavelengths to a spacing closer to two wavelengths. The reduction is greatest for the bulk waves traveling the longest in the wedge 170 (i.e., those that travel along the distance d₄). The reduction is progressively lower for the other steps.

The stepped transducers need not be disposed in the same corner of the substrate 164. In other embodiments, the 45 degree wedge or other stepped transducers for the X and Y axes are disposed in different corners. In yet another embodiment, a single stepped transducer having a 45 degree or other stepped mode conversion wedge may be used to receive signals for both X and Y axes. The piezoelectric elements are mounted or disposed on both flat faces of the mode conversion wedge, which is then oriented with the piezoelectric elements closest to the frit or reflector arrays so that the steps introduce the delays that result in mitigation of the dispersion. The stepped faces of the transducer are reached in this embodiment despite being behind the piezoelectric elements, insofar as the acoustic energy reflects off of the back side of the transducer to reach the piezoelectric element.

The stepped transducers of the embodiment of FIG. 5 may be used with other touch input systems, and are not limited to bezel-free touchscreens. The stepped transducers may be mounted or disposed on a front side of a substrate of the touch input system, which may also be used in a device with a bezel configured to cover the stepped transducers.

The transducer arrangements are not limited to those having transducers disposed in a corner of a touchscreen or other touch input system substrate. For example, one or more transducers may be disposed in along a side of a substrate.

The above-described dispersion mitigation technique may be implemented independently of the dispersion level analysis described herein. Using stepped transducers to reduce the spreading or dispersion of the incoming acoustic energy may increase the resolution of touch input systems, regardless of whether such systems analyze the dispersion level of the waveforms.

While the invention has been described above by reference to various embodiments, it should be understood that many changes and modifications can be made without departing from the scope of the invention. For example, a higher number of steps may be used in the stepped transducer design to mitigate the dispersion caused by the angled frit arrays. It is therefore intended that the foregoing detailed description be regarded as illustrative rather than limiting, and that it be understood that it is the following claims, including all equivalents, that are intended to define the spirit and scope of this invention.

1. A method of detecting a touch event, the method comprising:
transmitting acoustic signals across a substrate;
receiving the acoustic signals, the received acoustic signals having a waveform profile with a dip indicative of a touch on the substrate;
determining a dispersion level of the dip from the waveform profile; and
determining a location coordinate of the touch on the substrate based on the dispersion level.

2. The method of claim 1, further comprising:
determining a timing of the dip in the waveform profile; and
generating a further location coordinate of the touch on the substrate based on the timing.

3. The method of claim 1, further comprising receiving a reflective acoustic signal created by the interaction of the acoustic signal with the touch, wherein determining the location coordinate is further based on an arrival time of the reflective acoustic signal.

4. The method of claim 3, wherein the transmitted acoustic signal includes a plurality of cycles.

5. The method of claim 4, wherein the plurality of cycles leads to a pulse duration approximately equal to a width of a reflector array used to redirect the acoustic signal.

6. The method of claim 3, wherein receiving the reflective acoustic signal comprises capturing the reflective acoustic signal via one of a plurality of transmit transducers in communication with the substrate, each transmit transducer being switched to a receive mode after the acoustic signal is transmitted.

7. (canceled)

8. A system comprising:
a substrate configured to support propagation of acoustic signals across the substrate;
a first transducer in communication with the substrate and configured to receive the acoustic signals after the propagation of the acoustic signals across the substrate and to generate a waveform representation of the received acoustic signals; and
a controller configured to detect a touch on the substrate occurring during the propagation of the acoustic signals, the controller detecting the touch based on a dip in the waveform representation of the received acoustic signals, and the controller being further configured to determine a first location coordinate for the touch based on a dispersion level of the dip.

9. The system of claim 8, wherein the substrate has first and second axes, and wherein the controller is configured to determine a timing of the dip in the waveform representation of the captured acoustic signal and to generate a second location coordinate of the touch based on the timing.

10. The system of claim 9, wherein:
the first transducer is one of a plurality of receive transducers in communication with the substrate;
a further transducer of the plurality of transducers is positioned to capture a further acoustic signal and to generate a further waveform representation of the further acoustic signal; and
the controller is configured to determine the first location coordinate and the second location coordinate of the touch based on a timing of a further dip in the further waveform representation and a dispersion level of the further dip, respectively.

11. (canceled)

12. The system of claim 10, further comprising a plurality of reflector arrays on the substrate, each reflector array comprising a set of reflectors oriented on an angle to redirect the acoustic signal along a path toward a respective one of the plurality of receive transducers, wherein each receive transducer comprises a plurality of piezoelectric elements distributed across a width of the redirected acoustic signal and offset from one another along the path of the redirected acoustic signal to compensate for the angle of the reflector array.

13. (canceled)

14. The system of claim 8, further comprising a plurality of receive transducers in communication with the substrate, the plurality of receive transducers including the first transducer and a second transducer configured to capture a reflective acoustic signal created by the interaction of the acoustic signal with the touch, wherein the controller is configured to determine the coordinate based on an arrival time of the reflective acoustic signal.

15. The system of claim 14, wherein one or more of the plurality of receive transducers are configured as transmit transducers, each transmit transducer being switched to a receive mode after the acoustic signal is transmitted.

16. The system of claim 8, wherein the acoustic signal is a surface acoustic wave (SAW) signal.

17. (canceled)

18. (canceled)

19. (canceled)

20. (canceled)

21. (canceled)
